(19) United States
(12) Patent Application Publication
(10) Pub. No.: US 2025/0225650 A1
(43) Pub. Date: Jul. 10, 2025

(54) Recognizing defects on a homogeneous surface of a moving object

(71) Applicant: SICK AG, Waldkirch (DE)

(72) Inventors: Romain MÜLLER, Waldkirch (DE); Andreas REICHERT, Waldkirch (DE); Dirk STROHMEIER, Waldkirch (DE)

(21) Appl. No.: 19/010,644

(22) Filed: Jan. 6, 2025

(30) Foreign Application Priority Data
Jan. 9, 2024 (DE) 102024100376.6

(51) Int. Cl. G06T 7/00; G06V 10/82; H04N 25/47

(52) U.S. Cl. CPC G06T 7/001; G06V 10/82; H04N 25/47; G06T 2207/10152; G06T 2207/20081; G06T 2207/20084; G06T 2207/30108

(57) ABSTRACT

A method for recognizing defects on a homogeneous surface of an object during a movement of the object is provided, wherein an image of the homogeneous surface is recorded and the image is evaluated as to whether it has defects. In this respect, the image is recorded by an event-based image sensor that detects events of a changing intensity with a plurality of pixel elements; the recording takes place over a time interval within which the homogeneous surface moves on over at least some pixel elements of the image sensor; the events are corrected in accordance with a time that has elapsed since a reference point in time and the movement that has taken place during the elapsed time; and the corrected events are collected in an image that is then evaluated with respect to the defects.

The invention relates to a method and to a camera device for recognizing defects on a homogeneous surface of an object during a movement of the object respectively.

A CMOS image sensor is as a rule conventionally used for the image capturing. It records images at a specific recording frequency and for this purpose integrates all the charges within an exposure time that are produced by incident photons. With a moving object, however, depending on the exposure time, the integrated photons of a pixel no longer originate from the same location on the object and motion blur is produced. For the recognition of defects, there is the special challenge that the recording frequency has to be fast enough so that a defect is registered at all and is not lost in the motion blur so that then, however, sufficient exposure times are no longer possible, at least at higher speed of the object movement. The application could best be resolved using a line scan camera that reaches a recording frequency of several hundred KHz. A line scan camera, however, has an only very limited field of view and the problems of the extremely short exposure times remain.

More recently, an innovative camera technique has arisen, the so-called event-based camera. It is also called a neuromorphological camera based on the retina and the visual cortex. There is neither a fixed refresh rate nor a common reading of pixels in an event-based camera. Instead, each pixel individually checks for itself whether it has determined a change in intensity. Image information is only generated and output or read in this case, and indeed only by this pixel. Each pixel is thus a kind of independent motion detector. A detected movement or other change of the intensity is individually or asynchronously reported as an event. The event-based camera thereby reacts extremely quickly to the dynamics in the scene. Images generated from the events cannot be as intuitively grasped by the human eye because the static image portions are missing

An event-based camera is, for example, described in a white paper by the company Prophesee that can be downloaded from their internet site. Respective pixel circuits for an event-based camera are known from WO 2015/036592 A1, WO 2017/174579 A1 and WO 2018/073379 A1. An event based camera for code reading is used in EP 3 663 963 A1.

The prior art describes the use of an event-based camera for recognizing defects on a homogeneous surface of a moving object. It is also not sufficient to only used an event-based camera instead of a conventional high speed camera. Events could be accumulated analogously to an exposure time using the event-based camera. As with conventional motion blur, the events are then scattered in the course of the movement over the field of view and cannot be associated with any defect. Conversely, the events could be processed into images on very brief time scales. This emulates a conventional high speed camera. Smaller defects would then only generate isolated individual events that would not be distinguishable from noise events.

The still unpublished European patent application having the file reference 23200688.2 discloses a camera device having an event-based image sensor to record an object stream. The events are then corrected in accordance with a time elapsed since a reference point in time and the movement that had taken place during the elapsed time, that is so-to-say led back in the opposite direction using the elapsed time of the movement to thus compensate the motion blur. A recognizing of defects is not provided, however.

U.S. Pat. No. 11,138,742 B2 describes an event-based feature tracking while determining an optical flow. The procedure is very laborious mathematically and again no recognition of defects is described.

It is therefore the object of the invention to improve an optical recognition of defects on an homogeneous surface of an object.

This object is satisfied by a method and by a camera device for recognizing defects on a homogeneous surface of an object in accordance with the respective independent claim. An image is recorded for this purpose, with it immediately becoming clear that in accordance with the invention a dataset of events is initially recorded and an image is only later generated therefrom. The object is in a movement relative to the recording position or the recording camera device. The expectation for the object that is, for example, inspected as part of a quality inspection or in a production process, is preferably a continuously homogeneous surface. Deviations from a homogeneous surface that may have the most varied causes such as microcracks or particles are recognized as defects. An evaluation shows whether such defects are present, and preferably at which positions.

The invention starts from the basic idea of recording the image using an event-based image sensor and to remove the intermediate movement by calculation in consecutively detected events. An event-based or neuromorphological image sensor has a plurality of pixel elements, for example in a linear or matrix arrangement. The differences from a conventional image sensor have been briefly discussed in the introduction. The pixel elements respectively recognize changes in the intensity instead of measuring the respective intensity as customary. Such a change that should preferably be fast enough and should exceed a noise level is one of the eponymous events. In addition, signals are only provided or read on such a change in the intensity, and indeed only of the affected pixel or the affected pixels.

The recording takes place over a time interval that is at least so long that the movement of the object within the time interval leads a possible defect through a plurality of pixel elements. The pixel elements that perceive a sufficient intensity change trigger corresponding events at individually different points in time. The points in time are expressed, without any restriction of generality, as the time elapsed since a reference point in time. The reference point in time is arbitrary in principle,, preferably the start of the time interval. A differing choice of the reference point in time is easily correctable; it only results in a displacement of the generated image as a whole. The object has continued to move during the elapsed time. To compensate this movement in the events, a respective event is calculated back to the location where it was at the reference point in time. If an image is generated from the events thus corrected, this thus effectively at least approximately corresponds to a recording at rest instead of in motion. Since, however, the actual recording takes place in motion, the event-based pixel elements can respond to defects whereas no event would arise, even at defects, in a true position of rest except for pure noise.

The method is a computer implemented method that runs, for example, on a processing unit of a camera and/or on a processing unit connected to a camera.

The invention has the advantage that even very small changes due to defects are detected by the event-based recording. The event-based technology permits the inspection of fast-moving objects with continuous data recording and very precise time stamps. Due to the motion compensation in the evaluation of the events in accordance with the invention, individual events or a few events are also accumulated when they originate from a defect and therefore occur systematically and not only randomly due to noise and are then detectable after all in sum.

The object is preferably a film for manufacturing a battery. The term battery is broad enough here to include rechargeable batteries or storage batteries. Such films satisfy the requirement of a homogeneous surface in the non-defective case. At the same time, unrecognized defects for the produced battery are a great problem; an insufficient function of the film results in heat losses and capacity losses and in the extreme case even in fires and explosions.

The object is preferably an anode film, a cathode film, or a separator film. All the films relevant to the production of batteries can thus be checked for defects. Advantageously, a plurality of or all the types of films are already checked for defects during manufacture, in particular directly in the production process, so that flaws due to the defects are avoided in advance.

Particles in the order of magnitude of the thickness of the film, in particular particles from a diameter onward of at most half the thickness of the film, are preferably already recognized as defects. Larger defects are thus above all recognized; the challenge is in the recognition of very small structures. The order of magnitude means, as customary, a permitted factor n or 1/n, where n<10 with respect to the thickness of the film, that is, for example, twice or three times the thickness. Half the thickness to this extent has a special meaning since even smaller particles can no longer penetrate a film and corresponding defects therefore do not necessarily have to be detected. In absolute figures, these specifications for typical films,, in particular battery films, means an order of magnitude of some micrometers, for example 5 μm, 10 μm, 15 μm, or 20 μm.

The lower side and the upper side of the film are preferably recorded and checked for defects. Defects are thus recognized on both sides. Two image sensors or cameras are preferably used for this purpose, with mirror designs also being conceivable in connection with a field of view of a single image sensor divided into two.

The object is preferably differently illuminated for the recording of the image in a plurality of illumination zones. For this purpose, a plurality of illumination units or a plurality of modules of an illumination unit are preferably provided. The field of view of the image sensor is thus divided into the different illumination zones. Defects can thereby be recognized in different illumination scenarios and with a thus still lower error rate. The illumination zones are preferably free of mutual overlap; otherwise further illumination zones are effectively simply produced by the superposition of light in the overlap zones. Overlap zones can be taken into account as such in the evaluation or excluded therefrom in dependence on the embodiment. The advantage of the illumination zones is that they can be simultaneously generated. With a complete lighting, the illumination could only be sequentially varied so that the recording, however, takes place in different stages of the movement. It is nevertheless not precluded that illumination zones or illumination units or modules are activated in a time pattern.

Corrected events are preferably respectively only collected within the same illumination zone. This is simple to implement since the pixel elements of the image sensor are directed to a specific location and can thus be associated with an illumination zone. The different illumination scenarios would intermix without this association. A division into illumination zones can also be helpful with such averaging effects, but the best result is achieved when the illumination scenarios are individually evaluated. This is possible without time loss due to the possibility of activating illumination zones simultaneously.

The illumination zones preferably differ from one another in at least one of the following illumination possibilities: reflected light, transmitted light, polarization, intensity, spectrum, angle of incidence, illumination pattern. This is achievable by corresponding properties of illumination units or modules. A detection in reflected light preferably takes place from both sides. This is rarely required, but nevertheless conceivable, with transmitted light because a defect on this side or that side of a partially transparent object can already produce a different effect. Defects of the most varied kind are made visible by variation in the other named light properties so that the recognition rate overall profits.

The time interval preferably corresponds to the duration within which the homogeneous surface moves through an illumination zone or the whole field of view of the image sensor. The maximum number of events can thus be detected, namely those in the same illumination scenario or overall. This also improves the recognition rate for defects.

The movement taking place during the time interval is preferably specified by a parameterization, measured by means of an additional sensor, or determined from the events. A fixedly specified movement can be compensated by means of parameterization, for example by indicating a speed of a uniform movement, with more complex movements also being parameterizable. It is conceivable here to take over the parameters of the movement from settings of a conveying device that moves the object to be recorded or, for example, rolls a film up or unrolls it. The measurement by an additional sensor, for example an incremental encoder, at a conveying device means a little more effort, but is in turn more flexible and more adaptable. A third possibility comprises determining the movement from the measured data of the image sensor, namely the events. In this case, there are no specifications or additional information on the movement that is rather independently estimated. No interfaces thereby have to be provided and as with the measurement by an additional sensor it is ensured that the actual movement is considered and not only a desired or specified movement.

The object preferably moves only in one direction. This is a frequent application and substantially simplifies the correction of the events. The movement in particular takes place uniformly, that Is at a constant speed. The example application of a conveying device or the rolling up or unrolling of films has already been named; the movement is as a rule uniform here except for occasional switchover procedures. The speed amounts to some meters per second, is typically in the interval of 0.5-1.5 m/s corresponding to a typical conveying speed or running speed of a film.

The image sensor is preferably aligned with the rows or columns of the pixel elements in the direction of movement. The camera is therefore attached with respect to the object flow such that the movement runs along the rows or columns of the pixel elements. This facilitates the further processing and avoids discretizing artifacts.

The events are preferably corrected in accordance with the specification Xₙ=X−ν * dT, where X is the position of the pixel element triggering the event, Xₙ new position, ν speed of the movement, and dT time elapsed since the reference point in time. In this respect, the direction of movement is called the X direction without restriction of generality; it could always be achieved by a simple rotation when the direction of the movement does not coincide with the lines of the image sensor. No correction in the Y direction is thus required because the object stream does not move in this direction. The units are selectable; for example, the positions correspond to the pixel position on the image sensor, the elapsed time is in seconds, and the speed is given in pixels/second.

The events themselves are preferably evaluated for the correction corresponding to the time elapsed since a reference point in time and the movement that had taken place during the elapsed time, without first composing an image therefrom, and the corrected results are only finally collected in an image after the correction, the image then being evaluated with respect to the defects. Events only rarely occur on a recording of a homogeneous surface. It is therefore sensible to keep the evaluation at the level of the events for as long as possible (sparse data, sparse evaluation). It is even conceivable also to find the defects at this level of the events; for example as an accumulation of events and thus never to compile an image. However, the way of making use of proven image evaluations is thereby blocked.

The image is preferably evaluated using a process of machine learning, in particular a neural network, as to whether it has defects. The greater challenge in the recognition of small defects is to obtain optically sufficient information. Once an image in which the defects are visible is present thanks to the invention, processes can be made use of for the final recognition of the defects that are also suitable for conventionally recorded images. This is particularly flexibly possible with machine learning, with a neural network or even more preferably a deep convolutional neural network preferably being used. In particular a supervised learning with annotated or labeled training data is suitable for the training. Objects of the kind to be examined, that is in particular films, are presented for this purpose and a respective evaluation from external is specified for this purpose and optionally where there are defects. The process of machine learning can then generalize in later operation.

A classical image evaluation is also possible. It is to be expected that the image is largely blank, at least after application of a noise threshold, since the homogeneous surface without defects does not trigger any events. Clusters of events in which a minimum number of events are detected at a pixel of the generated image can be sought and/or with the demand that events are detected at a minimum number of adjacent pixels in the image. It must be noted that in this connection pixels mean the picture elements in the image generated from the corrected events that may not be confused with the pixel elements that have triggered the events.

An event preferably has respective coordinate information of the associated pixel element, time information, and/or intensity information. A conventional data stream of an image sensor comprises the intensity values or gray scale values of the pixels and the spatial reference in the image sensor plane is produced in that all the pixels are read in an ordered sequence. In the event-based image sensor, data tuples per event are instead preferably output that make the event associable. In this respect, the location of the associated pixel element such as its X-Y position on the image sensor, the polarity, or the direction ±1 of the intensity change or the intensity measured at the event, and/or a time stamp are preferably recorded. Only a very few data thereby have to be read despite the higher effective image refresh rate.

The event-based image sensor preferably generates image information having an update frequency of at least one KHz or even at least ten KHz and more. The update frequency of a conventional camera is the refresh rate or frame rate. Such a common refresh rate is unknown to the event-based camera since the pixel elements output or refresh their image information individually and on an event basis. There are extremely short response times here which would only be able to be achieved with a conventional camera at huge costs with a thousand or more images per second; with an event-based still possible even higher refresh rate, this would no longer be reproducible technically with a conventional camera.

A respective pixel element preferably determines when the intensity detected by the pixel element changes and generates an event exactly then. In other words, this again expresses the special behavior of the pixel elements of an event-based camera or of an event-based image sensor that has already been addressed multiple times. The pixel element checks whether the detected intensity changes. Only that is an event and image information is only output or read on an event. A type of hysteresis is conceivable in which the pixel element still ignores a defined change of the intensity that is too small and does not consider it an event.

The pixel element preferably delivers differential information as to whether the intensity has decreased or increased as the image information. Image information read out of the pixel element is therefore, for example, a polarity a sign +1 or −1 depending on the direction of change of the intensity. A threshold for intensity changes can be set here up to which the pixel element still does not trigger an event. The duration of an intensity change can also play a role in that, for example, the comparison value for the threshold is tracked with a certain decay time. Too slow a change then does not trigger an event even if the intensity change was above the threshold in sum over a time window longer with respect to the decay time.

An integrating variant is also conceivable as an alternative to a differential event-based image sensor. The pixel element then delivers an integrated intensity as the image information in a time window determined by a change of the intensity. The information is here not restricted to a direction of the change of intensity, but the incident light is integrated in a time window fixed by the event and a gray scale value is thereby determined. The measured value thus corresponds to that of a conventional camera, but the point in time of the detection remains event-based and coupled to a change of intensity.

The camera device in accordance with the invention for recognizing defects on a homogeneous surface of an object, in particular of a film, during a movement of the object relative to the camera device has an event-based image sensor; it is thus an event-based or neuromorphological camera and consequently not a conventional camera with a conventional image sensor. A control and evaluation unit of the camera device performs one of the embodiments of the method in accordance with the invention. The control and evaluation unit can be integrated in the camera or can be external or a mixed form of the two.

The invention will be explained in more detail in the following also with respect to further features and advantages by way of example with reference to embodiments and to the enclosed drawing. The Figures of the drawing show in:

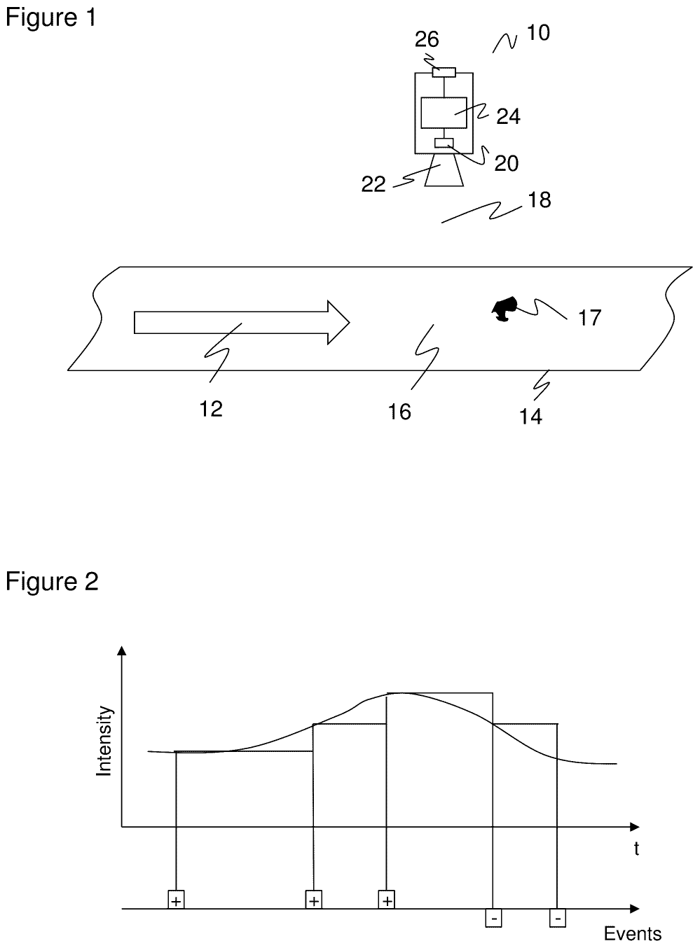

FIG. 1 a camera in an application above a moving film;

FIG. 2 a schematic representation of a time-dependent intensity progression to explain the functional principle of an event-based camera;

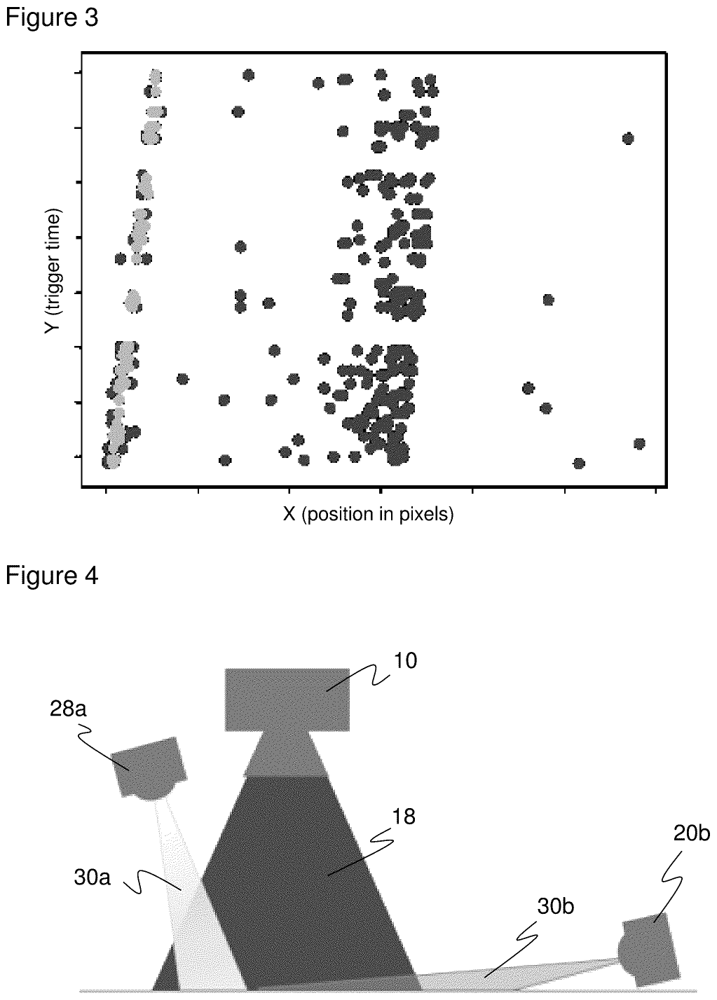

FIG. 3 an exemplary displacement-time graph of events; and

FIG. 4 a schematic representation to explain an illumination having a plurality of illumination zones.

FIG. 1 shows a camera 10 that records an object 14 moving in a direction 12 and having a homogeneous surface 16 within a field of view 18. In this example, the object 14 is a film and in particular a battery film that is moved or rolled up or unrolled by means no longer shown. Alternatively, objects 14 on a conveyor belt or other moving objects 14 are conceivable. Wider objects 14 or other surfaces such as the lower side of the object 14 can also be detected by the use of additional camera and/or of mirrors and the like. The inspection of the object 14 by the camera 10 has the objective of recognizing or preferably also of localizing possible defects 17 in the homogeneous surface 16. The defect 17 shown in FIG. 1 has a greatly exaggerated size for representation reasons.

The camera 10 captures image information of the moving object 14 using an image sensor 20 by an objective 22 of any design known per se that is only shown purely schematically. The image sensor 20 as a rule comprises a matrix arrangement or row arrangement of pixels and is an event-based image sensor. Unlike a conventional image sensor, it is not charges that are collected via a certain integration window in the respective pixels and the pixels are not then read together as the image, but rather events are triggered and forwarded by the individual pixels when an intensity change is produced in their field of view. The principle of an event-based image sensor will be explained in more detail below with reference to FIG. 2.

A control and evaluation unit 24 is connected to the image sensor 20 and controls its recordings and reads and further processes the respective events. The control and evaluation unit 24 has at least one digital processing module such as at least one microprocessor, at least one FPGA (field programmable gate array), at least one DSP (digital signal processor), at least one ASIC (application specific integrated circuit), at least one VPU (video processing unit), or at least one neural processor. The control and evaluation unit 24 can moreover be provided at least partly externally to the camera 10, for instance in a superior control, a connected network, an edge device, or a cloud.

The camera 10 outputs information such as image data or evaluation results acquired therefrom via an interface 26, that is in particular the absence or presence of a defect 17, preferably with the position. Provided that the functionality of the control and evaluation unit 24 is provided at least partially outside the camera 10, the interface 26 can be used for the communication required for this. Conversely, the camera 10 can obtain information from further sensors or from a superior control via the interface 26 or via a further interface. It is thereby possible, for example, to transmit a fixed speed of the movement of the object 14 or a current speed of the movement of the object 14 measured by means of an additional sensor, not shown, to the camera 10 or to obtain geometrical information on the objects 14, in particular their distance from the camera 10 for a focal setting or other setting of the objective 22. The camera 10 can contain further elements or can be connected to further components, for example to a sensor such as a light barrier or a light scanner, via which a recording start or a recording end is triggered.

If the object 14 to be inspected is a non-transparent film, detection is preferably made from both sides in order also to recognize defects 17 on the lower side. A transparent film can be detected in a transmitted light process. There are three types of film that can be checked particularly in the case of battery production: the cathode film, the anode film, and the separator film. To locate all the defects 17, six homogeneous surfaces 16 are preferably to be checked here, namely the upper and lower sides of all three film types. This is preferably done in good time within the framework of the production so that the finished batteries only comprise films without defects 17. A typical size of the defects 17 to be located is 5 μm, corresponding to half the thickness of a separator film, at movement speeds of 0.5-1.5 m/s. If more cameras 10 are required to cover a wider object 14 or for additional perspectives, for example from the lower side, the functionality of the control and evaluation unit 24 can be distributed almost as desired. It must still be mentioned that cutting edges can be inspected in the same manner.

FIG. 2 shows in the upper part for the explanation of the functional principle of the event-based image sensor 20 a purely exemplary temporal intensity development in a pixel element of the image sensor 20. A conventional image sensor would integrate this intensity development over a predefined exposure time window; the integrated values of all the pixel elements would be output in the cycle of a predefined frame rate and then reset of the next frame.

The pixel element of the event-based image sensor 20 instead reacts to an intensity change individually and independently of a frame rate. Points in time at which an intensity change was found are respectively marked by perpendicular lines. Events at these points in time are shown in the lower part of FIG. 2 with plus and minus in dependence on the direction of the intensity change. It is conceivable that the pixel element does not react to any and all intensity changes, but only when a certain threshold has been exceeded. The advanced demand can be made that the threshold is exceeded within a certain time window.

Comparison values of prior intensities outside the time window are then so-to-say forgotten. A pixel element can advantageously already be individually configured, at least roughly, to the recognition of flashes by the threshold and/or time window.

The events generated by a pixel element are read out individually at the time of the event or preferably in readout cycles of the duration dt and thus transferred to the control and evaluation unit 24. In this respect, the time resolution is in no way restricted to dt since the pixel element can provide the respective event with any desired fine time stamp. The cycles fixed by dt are also otherwise not to be compared with a conventional frame rate. A higher frame rate conventionally means a data volume scaled up directly linearly by the additional images. With the event-based image sensor 20, the data volume to be transmitted does not depend on dt except for a certain administration overhead. If namely dt is selected as shorter, fewer events are also to be processed per readout cycle. The data volume is determined by the number of events and is thus largely independent of dt.

There are also integrating event-based cameras in addition to differential event-based cameras. They react in a very analogous manner to intensity changes. Instead of outputting the direction of the intensity change, however, the incident light is integrated in a time window predefined by the event. A gray scale value is thereby produced. Differential and integrating event-based cameras have a different hardware design and the differential event-based camera is faster since it does not require any integration time window. Reference is additionally made again to the patent literature and scientific literature named in the introduction with reference to the technology of an event-based camera.

The image information of the event-based image sensor 20 is not an image, but an event list. A respective event is, for example, output as a tuple having the sign of the intensity change with a differential event-based camera or with a gray scale value with an integrating event-based camera, the pixel position on the image sensor 20 in the X and Y directions and a time stamp. The now described correction of events for an intermediate movement can first take place at the level of events or event lists. An image in the conventional sense for a defect recognition is preferably only finally generated from the already corrected events.

FIG. 3 shows an exemplary displacement-time graph from events of some pixel elements of the image sensor 20 that have been picked out by way of example and that are adjacent to one another in the direction 12 of the movement. The position of the pixel respectively triggering an event is entered on the X axis, with the X direction being the line direction and the direction of movement without any restriction of generality. The Y axis is the time axis. A respective point in the displacement-time graph thus corresponds to an event in a pixel at position X at the trigger time t. The displacement-time graph shown serves for illustration; the control and evaluation unit 24 can equally work directly with event lists or in any other desired representation.

A defect 17 triggers events successively in adjacent pixels in the course of its movement. In FIG. 3, the defect 17 is so small that only one respective pixel triggers at the same time. With a uniform movement, a straight line results in the displacement-time graph that is highlighted by brighter points for illustration. The slope of this straight line is proportional to the speed of the uniform movement or is equal to the speed in the selected units of the axes. The movement speed can be estimated from this straight line that is alternatively specified or measured by an additional sensor. A calibration should still be carried out so that the slope of the straight line or another piece of speed information is detectable and usable for the further steps. A non-linear calibration by means of polynomial fitting or the like is possibly required for an objective 22 having high geometrical distortion. A plurality of calibrations or, in the non-linear case, interpolations can be carried out to take account of different speeds.

Knowledge of the speed, in the unit of pixels/s, for example, now makes it possible to correct the movement of the defects 17 in the recorded events. Figuratively speaking, the events should be converted to a common reference point in time using the known intermediate movement. The reference point in time is the start of a time interval in which events are collected for an image recording in the following without any restriction of generality. This choice is ultimately free and not particularly substantial since a differing reference point in time only generates a common offset of the total movement-compensated image.

The previous value X of the event can then be converted per event into a corrected value Xₙ in accordance with the rule Xₙ=X−ν * dT. ν is here the speed, in particular determined as a slope, preferably in the unit pixels/s, and dT is the time elapsed since the reference point in time observed according to the trigger point in time of the event. There is nothing to be corrected in the Y direction since the movement takes place in the X direction. The trigger point in time of the event is at least no longer of interest for the method in accordance with the invention after this conversion, but would naturally still be available for other evaluations.

In a somewhat more complete notation, let an event e be observed at a point in time t at a position (x, y) of the image sensor 20 that has the polarity p. The event is transformed in accordance with the above calculation rule corresponding to the speed v: e(t,xₙ,y,p)=e (t,x−v * dT,y,p). All the events are subjected transformation. In particular an FPGA is suitable for at least some of the calculation steps that are required for this and that frequently have to be carried out, that are not particularly complex per se, and that are simple to parallelize. The new x coordinate is not a whole number as a rule and can then be rounded. It may be advantageous from an implementation viewpoint, in particular in an FPGA, not to calculate using floating point numbers, but rather to select a format with fixed decimal places and to convert roundings and the like via bit shift operation.

The events corrected in this manner can now be collected in a matrix using their (x, y) coordinates; the result then corresponds to a conventional image. Thanks to the correction for the movement, events that a defect 17 has triggered contribute to the pixels of this image at the same locations. Small or poorly visible defects 17 thereby also become recognizable. Such a defect 17 does not necessarily trigger an event in every pixel element of the image sensor 20. In the course of the movement, the defect 17, however, successively moves into the field of view 18 of, for example, 720 pixel elements of an image sensor line if an orientation of the movement in the line direction of the image sensor 20 is assumed without any restriction of generality. Even a poorly recognizable defect 17, that, for example, only triggers an event every 10th time in a pixel element, accumulates then into a total signal of 72 and this can be clearly distinguished from noise. The correction of the movement provides that this total signal is able to be accumulated, unlike the previously very thinly distributed individual events in every 10th pixel of the calculation example that are still below the noise boundary.

In the just explained example, it was implicitly assumed that every event contributes with a polarity of +1, that is the events are counted onefold. A gray scale image is then produced in which the brightness corresponds to the number of events. Such a gray scale image can, for example, be evaluated by a method of machine learning, in particular a neural network, as to whether a defect 17 is present. Alternatively, conventional image evaluations can be used. After the correction, as explained, the gray scale value generated by a defect 17 is pronounced enough to reliably distinguish it from the otherwise homogeneous background that is only imparted by noise.

There are alternative possibilities to collect the corrected events in an image. It is thus conceivable to sum events while taking account of the sign of the polarity so that positive and negative events cancel each other out. It is also conceivable to deduct an absolute number and a sum formed while taking account of the sign from one anther, whereby the positions are shown at which a particularly large amount of events have canceled one another out in the image. This, for example, indicates an unstable or unreliable image feature. An image of only positive events and/or of only negative events is furthermore conceivable. The polarity thus makes it possible to selectively highlight different aspects in the image that can be important for a downstream defect recognition.

The time interval in which events are collected for a respective image is generally a free parameter. A preferred upper limit is the time that an object requires to pass through the field of view 18. Fractions thereof are, however, also conceivable, for example to concentrate on specific partial regions or objects or to generate two or more consecutive recordings per passage time of an object. Such partial regions can, for example, be different illumination zones that will be explained in more detail further below in connection with FIG. 4. The image sensor 20 has a total of N pixels for the total field of view 18 or a corresponding fraction for a partial region in the direction of movement. The speed of the movement in pixels/s already discussed above accordingly only has to be multiplied by N to find how long events have been collected for an image. The evaluation preferably takes place in a rolling manner, i.e. a respective new image is generated and evaluated when the object 14 has moved on by one or also more pixels, with the oldest events respectively being dropped. The dynamic range of the image, that is the possible gray scale values, corresponds to N since every edge of a defect 17 triggers an event at most once in each pixel element.

FIG. 4 shows a schematic representation to explain an illumination by a plurality of illumination units or illumination modules 28a-b, with only two illumination modules 28a-b being shown by way of example. The plurality of illumination modules 28a-b enable the generation of different illumination zones 30a-b. Events are here preferably collected in the image to be evaluated within an illumination zone 30a-b. It is alternatively conceivable to collect events also over boundaries of illumination zones 30a-b, which produces an averaging effect. By varying the arrangement and the properties of the illumination modules 28a-b, the most varied illumination scenarios can be implemented that differ, for example, spectrally, that is in color, in polarization, in the angle of incidence, in the profile, or illumination pattern such as line, dots, grid, homogeneous, and much, much more, and in the intensity or its time behavior such as modulation or gradients. Dark field, transmitted light, reflected light, and other techniques can thus be mapped that make a plurality of different defects 17 visible. A polarization is in particular to be understood relative to the reception path, i.e. a polarizing filter is preferably also associated with the image sensor 20 in the case of a polarized illumination. It can in particular be detected with crossed polarization, that is with an illumination whose direction of polarization differs from that of a polarization filer in the reception path, even more preferably perpendicular to one another. The plurality of illumination scenarios substantially increase the likelihood that a defect 17 can actually be detected. The different illumination scenarios can be simultaneously implemented. This is a great advantage with respect to a conventional line scan camera that could at best vary the illuminations after one another so that the demands on its recording frequency would again be increased. As already discussed in the introduction, only a line scan camera can be considered at all since a conventional matrix camera has a much too low a recording frequency.

1. A method for recognizing defects on a homogeneous surface of an object during a movement of the object, wherein an image of the homogeneous surface is recorded and the image is evaluated as to whether it has defects,
wherein the image is recorded by an event-based image sensor that detects events of a changing intensity with a plurality of pixel elements; wherein the recording takes place over a time interval within which the homogeneous surface moves on over at least some pixel elements of the image sensor; wherein the events are corrected in accordance with a time that has elapsed since a reference point in time and the movement that has taken place during the elapsed time; and wherein the corrected events are collected in an image that is then evaluated with respect to the defects.

2. The method in accordance with claim 1, wherein the surface of the object is a film.

3. The method in accordance with claim 1,
wherein the object is a film for manufacturing a battery.

4. The method in accordance with claim 3,
wherein the object is an anode film, a cathode film, or a separator film.

5. The method in accordance with claim 4,
wherein the anode film, cathode film, and/or separator film are checked for defects during the manufacture of a battery.

6. The method in accordance with claim 1,
wherein particles in the order of magnitude of the thickness of a film are already recognized as defects.

7. The method in accordance with claim 6,
wherein particles from a diameter onward of at most half the thickness of the film are already recognized as defects.

8. The method in accordance with claim 1,
wherein the lower side and the upper side of the film are recorded and checked for defects.

9. The method in accordance with claim 1,
wherein the object is differently illuminated for the recording of the image in a plurality of illumination zones.

10. The method in accordance with claim 9,
wherein corrected events are respectively collected only within the same illumination zone.

11. The method in accordance with claim 9,
wherein the illumination zones differ from one another in at least one of the following illumination properties: reflected light, transmitted light, polarization, intensity, spectrum, angle of incidence, illumination pattern.

12. The method in accordance with claim 1,
wherein the time interval corresponds to the time duration within which the homogeneous surface is moved through an illumination zone or through the whole field of view of the image sensor;
and/or wherein the movement taking place during the time interval is specified by a parameterization, measured by means of an additional sensor, or determined from the events.

13. The method in accordance with claim 1,
wherein the object only moves in one direction.

14. The method in accordance with claim 13,
wherein the object only moves uniformly.

15. The method in accordance with claim 1,
wherein the events are corrected in accordance with the specification Xₙ=X−ν * dT, where X is the position of the pixel element triggering the event, Xₙ new position, ν speed of the movement, and dT time elapsed since the reference point in time.

16. The method in accordance with claim 1,
wherein the events themselves are evaluated for the correction corresponding to the time elapsed since a reference point in time and the movement that had taken place during the elapsed time, without first composing an image therefrom, and the corrected results are only finally collected in an image after the correction, the image then being evaluated with respect to the defects.

17. The method in accordance with claim 1,
wherein the image is evaluated using a process of machine learning as to whether it has defects.

18. The method in accordance with claim 17,
wherein the process of machine learning comprises a neural network.

19. The method in accordance with claim 1,
wherein an event has respective coordinate information of the associated pixel element, time information, and/or intensity information.

20. The method in accordance with claim 1,
wherein the event-based image sensor generates image information having a refresh rate of at least one KHz or even at least ten KHz. and/or wherein a respective pixel element determines when the intensity detected by the pixel element changes and generates an event exactly then.

21. The method in accordance with claim 20,
wherein the event has differential information whether the intensity has decreased or increased.

22. A camera device for recognizing defects of a homogeneous surface of an object during a movement of the object relative to the camera device, that has an image sensor for recording an image of the homogeneous surface and has a control and evaluation unit that is configured to evaluate the image as to whether it has defects,
wherein the image sensor is an event-based image sensor having a plurality of pixel elements that detect events of a changing intensity; and
wherein the control and evaluation unit is configured to record events over a time interval within which the homogeneous surface moves on over at least some pixel elements of the image sensor, to correct the events in accordance with a time that has elapsed since a reference point in time and the movement that has taken place during the elapsed time and to collect the corrected events in an image that is then evaluated with respect to the defects.

23. The camera device in accordance with claim 22, wherein the homogeneous surface is a film.
